(19) United States
(12) Patent Application Publication
(10) Pub. No.: US 2025/0320030 A1
(43) Pub. Date: Oct. 16, 2025

(54) Bucket Seat Accessory Organizer

(71) Applicant: Danco, Inc., Irving, TX (US)

(72) Inventors: Robert Jones, JR., Rockwall, TX (US); Les Underwood, Haslet, TX (US)

(21) Appl. No.: 19/174,692

(22) Filed: Apr. 9, 2025

Related U.S. Application Data
(60) Provisional application No. 63/632,633, filed on Apr. 11, 2024.

(51) Int. Cl. B65D 25/06; B65D 43/16; B65D 43/22; B65D 51/18; B65D 53/02

(52) U.S. Cl. CPC B65D 25/06; B65D 43/163; B65D 43/22; B65D 51/18; B65D 53/02; B65D 2251/0021; B65D 2251/0081

(57) ABSTRACT

A bucket accessory that may be secured over an opening in a top of a standard utility bucket to provide a lid for the bucket along with an organizable storage compartment and a seat is disclosed. The bucket accessory includes a base having a plurality of divided storage compartments and a lid that is selectively openable and closable relative to the base. The lid may be pivotably coupled to the base such as by a hinge assembly. When closed, the bucket accessory may be use as a seating surface. A gasket may be disposed between the base and lid to provide a fluid tight seal therebetween in the closed position, and a latch mechanism may secure the lid to the base to retain the lid in the closed position. Optional dividers may be placed in the base to customize the size and number of storage compartments in the base.

### CROSS-REFERENCE TO RELATED APPLICATION

This application claims the benefit of U.S. Provisional Application Ser. No. 63/632,633 filed on Apr. 11, 2024, which is incorporated herein by reference.

### BACKGROUND

Standard utility buckets are available at almost all home improvement and hardware stores. These buckets are often available in two-gallon, three-gallon, and five-gallon capacities and are versatile for many different uses, ranging from being used as a car wash soap reservoir to a storage vessel for sporting equipment, tools, etc. Lids for these buckets are also commonly available. However, with the increasing use of these buckets for outdoor activities such as camping and fishing, the industry continues to demand advances in options and versatility in bucket lid technology.

### SUMMARY

According to some embodiments, a bucket seat accessory organizer comprises a base with an interior storage compartment and a lid moveable from an open position to a closed position relative to the base. When in an open position, the interior storage compartment is accessible to store items, such as screws, washers, other hardware items, cell phones, ear buds, and other personal items. When in a closed position, the items within the interior storage compartment are secured within the compartment and protected from most exterior contamination, such as water or dust intrusion.

In some embodiments, a base is configured to couple to a standard bucket, such as a 3 gallon or 5-gallon bucket, to act as a lid for the bucket. The base may be coupled to the bucket by a threaded engagement or a snap-fit engagement. When coupled to the bucket, the base secures any items or materials inside the bucket and protects them from most exterior contamination, such as water or dust intrusion.

In some embodiments, a lid of a bucket seat accessory organizer is configured to be completely removable from a base. In these embodiments, the lid may be coupled to the base by a threaded engagement or a snap-fit engagement. When the lid is removed from the base, it is in an open position. When the lid is coupled to the base, it is in a closed position.

In other embodiments, a lid is configured to be openable and closable without requiring complete removal, detachment, or disconnection from the base. In some of these embodiments, the lid may be pivotably coupled to the base by one or more hinges. In other embodiments, the lid may be coupled to the base by a flexible piece of material or strapping connected at one end to the lid and at the other end to the base.

In a hinged embodiment, a hinge rod and hinge rod supports may be disposed on the lid and a hinge retainer may be disposed on the base for each hinge used. Any configuration that allows the lid to freely pivot (when unlatched, if a latch is included) relative to the base may be used. In some embodiments, hinges may allow for at least 180° of movement of lid 104 between a closed position and a fully open position of the lid. In other embodiments, hinges may limit a range of pivoting of lid 104 between 0° (in a closed position) to around 90°, or 0 to around 120°, or 0 to around 150°. In a preferred embodiment, lid 104 is disposed at an angle of least 100° when fully opened to prevent lid 104 from inadvertently falling closed while a user is accessing the storage compartment area within the base.

In some embodiments, a bucket seat accessory organizer may comprise a latch-and-catch to secure the lid to the base in the closed position. In one embodiment, the base may comprise a latch slot configured to receive and retain a portion of a latch on the lid until the latch is released from the latch slot by a user. In these embodiments, at least a portion of the latch extends downwardly from the lid to engage with the slot. In other embodiments, the orientation is reversed with the latch on the base and the slot on the lid. A portion of the latch may be selectively manipulated to bend or flex to disengage the latch from the latch slot when it is desired to open the lid. In embodiments where the lid is coupled to the base by a snap-fit or threaded engagement, a latch-and-catch is not required, but may still be used, particularly with a snap-fit coupling to provide added security.

In some embodiments, a bucket seat accessory organizer may further comprise a gasket that may be formed from an elastomeric material or foam. A gasket may be disposed between the lid and the base to aid in creating a seal between the base and the lid when the lid is in the closed position.

In some embodiments, a gasket may be disposed in a gasket channel. A gasket channel may be formed in (recessed) or on (protruding from) a surface of the lid or the base in an area where a portion of the gasket contacts a portion of both the lid and base when the lid is in the closed position. A gasket may be configured to form a fluid tight seal between the base and the lid when the lid is in a closed position. In some embodiments, the gasket may aid in protecting the contents of the storage compartment area in the base from dirt, dust, and/or moisture during use and/or storage of bucket seat accessory organizer.

In some embodiments, a bucket seat accessory organizer may further comprise an outer ridge configured to mate with a gasket or with a gasket channel (if used). Depending on placement of the gasket (or gasket channel), outer ridge may extend upwardly from an upper portion of the base to engage with the gasket (or gasket channel) on the lid or may extend downwardly from a bottom portion of the lid to engage with the gasket (or gasket channel) on the base. An outer ridge may compress against the gasket when the lid is in the closed position to further enhance sealing of the lid to the base.

In some embodiments, a base may generally comprise a substantially round outer sidewall corresponding to the size of a bucket with which bucket seat accessory organizer is to be used. In some embodiments, the base may comprise an inner sidewall that forms at least a portion of the storage compartment area. The inner sidewall is disposed inwardly of the outer sidewall. The inner sidewall is preferably sized to fit within an outer sidewall of a bucket with which bucket seat accessory organizer is to be used, to allow at least some of the storage compartment area to be disposed within a body of the bucket when the base is coupled to the bucket. In some embodiments, the majority of the height of the storage compartment area is disposed within the body of the bucket when the base is coupled to the bucket. Preferably at least some of the height of the storage compartment area is disposed within the body of the bucket. In these embodiments, this ratio allows the bucket seat accessory organizer to not extend too far above an upper rim of the bucket, which could interfere with storage of the bucket while coupled to bucket seat accessory organizer.

In some embodiments, the base may further comprise a channel that receives an upper rim of a bucket. The channel may be disposed between the inner sidewall and the outer sidewall. In some embodiments, one or more reinforcing tabs are disposed within the channel to provide structural support. In still other embodiments, one or more coupling tabs may be disposed within the channel to aid in coupling the base to a bucket, such as by a snap-fit engagement with a lip or upper rim of the bucket. In still other embodiments, threads may be disposed within the channel to allow the base to engage with corresponding threads on the upper end of the bucket.

In some embodiments, a base may comprise one or more cutouts to allow insertion of a user's hand or fingers. According to some embodiments, a cutout is disposed on an outer sidewall of the base. In other embodiments, there are two opposing cutouts disposes substantially opposite from each other on the base. Preferably, such opposing cutouts are disposed in the other sidewall of the base. In some embodiments, it is not necessary to use a bucket handle with a bucket when a bucket seat accessory organizer is coupled to a bucket. An existing bucket handle connected to the bucket may be removed in these embodiments. One or more cutouts in the base may serve as a handle for the bucket in these embodiments.

According to other embodiments, a bucket seat accessory organizer may comprise a hanging tab. In some embodiments, a hanging tab is disposed on an outer sidewall of the base. In other embodiments, a hanging tab is disposed on the lid. A hanging tab may be used to hang the bucket seat accessory organizer for storage when not in use or for display in a store selling the bucket seat accessory organizer. According to some embodiments, a hanging tab may be removable from bucket seat accessory organizer, such as by a perforated connection to bucket seat accessory organizer.

In some embodiments, a storage compartment area within the base may be formed by an interior sidewall of the base and comprise a substantially circular shape.

In other embodiments, a storage compartment area may be formed by a portion of interior sidewall and a divider wall. A divider wall may be substantially straight, such that storage compartment area comprises a truncated circle or D-shape. In these embodiments, the base may have a substantially solid upper surface disposed between the divider wall and an adjacent portion of the outer rim or outer sidewall that provides an attachment area for a portion of a hinge assembly or other coupling structure to couple the lid to the base in embodiments where they are coupled in a manner that the lid is not intended to be completely removed from the base.

In some embodiments, a storage compartment area within a base further comprises a plurality of support walls that create a plurality of divided storage compartments. In one embodiment, each support wall is offset from a central location within the storage compartment area so that no support wall is centered (laterally or longitudinally) within the storage compartment area. In another embodiment, at least one support wall is offset from a central location within the storage compartment area and at least one other support wall is centered (laterally or longitudinally) within the storage compartment area.

In a preferred embodiment, the support walls are arranged to create at least two divided storage compartments that are substantially the same size and shape as each other (although the shapes may also be mirror images of each other). In a preferred embodiment, at least one divided storage compartment is the same shape as at least one other divided storage compartment but is sized differently. In other embodiments, support walls are arranged so that no divided storage compartments are substantially the same size as any other divided storage compartment. In still other embodiments, support walls are arranged so that no divided storage compartments are substantially the same shape as any other divided storage compartment. In some embodiments, at least one divided storage compartment is sized and shaped to hold a cell phone, having a length of around 6 to 9 inches and a width of around 3 to 6 inches. Any variations on support wall configurations and divided storage compartments may be used.

In another preferred embodiment, at least some support walls comprise divider slots that form a pair of aligned divider slots on oppositely facing surfaces of support walls. The divider slots are configured to receive an insertable and removable divider to sub-divide a divided storage compartment by altering a size and/or a shape of the storage compartment that comprises a support wall having aligned divider slots. In some embodiments, only longitudinally aligned support walls have divider slots. In other embodiments, only laterally aligned support walls have divider slots. In still other embodiments, any combination of support walls in any storage compartments may have divider slots.

A storage compartment area also comprises a bottom that may form a bottom of each divided storage compartment such that each divided storage compartment comprises the same lower level. In some embodiments, all divided storage compartments comprise the same depth as all other divided storage compartments, each having the same lower level and each support wall having the same height.

In other embodiments, one or more divided storage compartments may comprise a different depth from one or more other divided storage compartments. A different depth may be from not sharing a common lower level, or having support walls of different heights, or a combination thereof. In still other embodiments, a bucket seat accessory organizer may further comprise an insertable and removable horizontal divider to alter a height (or depth) of a divided storage compartment. Such horizontal divider may comprise a substantially flat surface and a plurality of feet configured to engage with a bottom of a divided storage compartment to allow items to be stored below and above the flat surface when the horizontal divider is in place.

In some embodiments, one or more of the divided storage compartments may comprise a weep hole or a plurality of weep holes that allow dirt, debris, and/or moisture to drain from the storage compartment.

In some embodiments, a lid may comprise a plurality of raised protrusions extending from a top surface. These protrusions may provide an aesthetic design feature and/or may enhance slip-resistance of the lid, particularly when it is functioning as a seat for a user.

In some embodiments, the lid may also comprise a plurality of ridges that extend downwardly from a bottom surface of the lid. In some embodiments, the ridges may be aligned with support walls in the storage compartment area or may be configured to align with selectively insertable and removable dividers, or both.

In some embodiments, a lid may be formed from a transparent or translucent polymeric material, such as a polycarbonate or acrylic, that allows the contents within the storage compartment area to be at least partially viewed through the lid. In some embodiments, the lid may be formed from a UV-resistant material.

In some embodiments, a bucket seat accessory organizer includes: a base configured to fasten to a utility bucket, the base including: an outer rim including a latch slot; a top coupled to the outer rim; and a storage compartment area disposed in the top and including a plurality of dividable storage compartments and a raised outer ridge extending around a perimeter of the storage compartment; and a lid rotatably coupled to the base by a hinge assembly that allows the lid to rotate relative to the base between an open position and a closed position, the lid including: a latch configured to engage the latch slot to secure the lid in the closed position; a gasket channel disposed about a perimeter of and extending from a lower surface of the lid; and a gasket disposed within the gasket channel and configured to form a fluid tight seal between the raised outer ridge of the base and the lid when the lid is in the closed position.

In some embodiments, a bucket assembly includes: a utility bucket; and a bucket seat accessory organizer coupled to the bucket, the bucket seat accessory organizer including: a base configured to fasten to a utility bucket, the base including: an outer rim including a latch slot; a top coupled to the outer rim; and a storage compartment area disposed in the top and including a plurality of dividable storage compartments and a raised outer ridge extending around a perimeter of the storage compartment; and a lid rotatably coupled to the base by a hinge assembly that allows the lid to rotate relative to the base between an open position and a closed position, the lid including: a latch configured to engage the latch slot to secure the lid in the closed position; a gasket channel disposed about a perimeter of and extending from a lower surface of the lid; and a gasket disposed within the gasket channel and configured to form a fluid tight seal between the raised outer ridge of the base and the lid when the lid is in the closed position.

Bucket seat accessory organizers according to embodiments herein provide more flexibility with arrangement of divided storage compartments using insertable and removable dividers. Added structural stability and rigidity are also provided by some embodiments herein, which allows the bucket seat accessory organizer to better function as a seat for a user, a footrest, and/or a step stool. A dual hinged coupling of the lid to the base in some embodiments allows for continued functionality and use in the event one hinge fails or is damaged through repeated use. Finger cutouts on the base in some embodiments provide advantages in coupling and uncoupling the bucket seat accessory organizer (or the base) from a bucket and in carrying the bucket with the bucket seat accessory organizer (or the base) connected to the bucket. Ergonomic features and usability enhancements in some embodiments as described herein, including protrusions on the upper lid surface for slip-resistance and a rounded shoulder on an outer edge of the base, provide for ease of use and greater comfort for a user.

### BRIEF DESCRIPTION OF THE DRAWINGS

For a more complete understanding of the present disclosure and so that the manner in which the features and advantages of the embodiments can be understood in more detail, reference is now made to the following brief description, taken in connection with the accompanying drawings and detailed description.

FIG. 1A shows a rear oblique exploded view of a bucket seat accessory organizer according to an embodiment of the disclosure.

FIG. 1B shows a front oblique assembled view of the bucket seat accessory organizer of FIG. 1.

FIG. 2 shows a side view of the bucket seat accessory organizer of FIG. 1.

FIG. 3 shows a cross-sectional side view of the bucket seat accessory organizer of FIGS. 1-2.

FIG. 4 shows a top view of a base of the bucket seat accessory organizer of FIG. 1.

FIG. 5 shows a bottom view of the base of the bucket seat accessory organizer of FIG. 1.

FIG. 6 shows a side view of a base of the bucket seat accessory organizer of FIG. 1.

FIG. 7 shows a top view of a lid of the bucket seat accessory organizer of FIG. 1.

FIG. 8 shows a bottom view of the lid of FIG. 7.

FIG. 9 shows a side view of the lid of FIG. 7.

FIG. 10 shows a front view of a divider according to an embodiment of the disclosure.

FIG. 11 shows a side view of the divider of FIG. 10.

The use of the same reference symbols in different drawings indicates similar or identical items.

### DETAILED DESCRIPTION

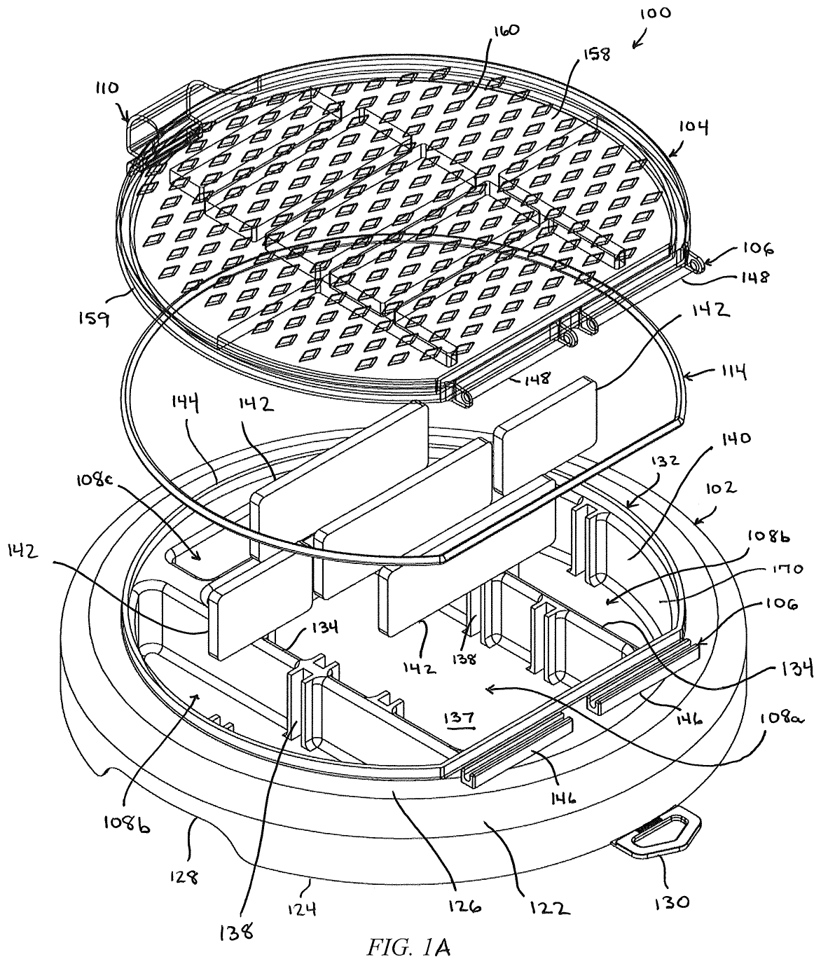

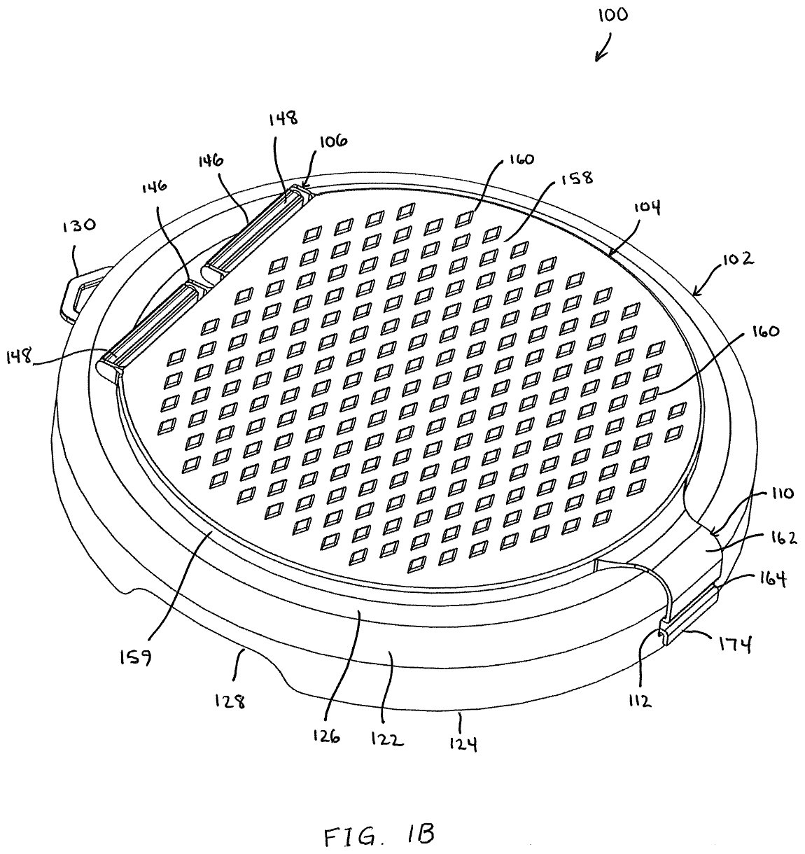

Referring to FIGS. 1 to 3, an oblique exploded view, a side view, and a cross-sectional side view of a bucket seat accessory organizer 100 are shown according to an embodiment of the disclosure. The bucket seat accessory organizer 100 may generally comprise a base 102 and a lid 104 configured to cover an interior storage compartment area 132 in base 102. Lid 104 may be selectively openable and closeable relative to base 102. Bucket seat accessory organizer 100 is configured to allow use with standard utility buckets, such as 5-gallon buckets, wherein bucket seat accessory organizer 100 functions as a removable lid for the bucket with its own openable (or removable) lid 104 to allow access to storage compartment area 132. Bucket seat accessory organizer 100 provides a smaller bucket-within-a-larger-bucket storage configuration, and may be useful as a seating surface, a footrest, and/or a step stool.

In some embodiments, lid 104 is pivotably coupled to base 102 by a hinge to allow lid 104 to be actuated from an open position, where storage compartment area 132 in base 102 is accessible, to a closed position, where storage compartment area 132 in base 102 is protected or sealed. In some embodiments, lid 104 is coupled to base 102 by a dual hinge assembly 106. In other embodiments, lid 104 may be coupled to base 102 by a snap fit or a threaded, rotatable connection to allow lid 104 to selectively be opened (or entirely removed from) base 102 and closed (or attached to) base 102. As will be discussed later herein, an open position may be associated with any position in which lid 104 is rotated around a hinge (or dual hinge assembly 106), or is removed for non-pivotable couplings, so that at least part of lid 104 is moved away from base 102 to allow access to contents stored in storage compartment area 132 in base 102. In other embodiments, an open position may be associated with a position in which lid 104 has been disengaged from a snap fit or threaded engagement with base 102. Similarly, a closed position may be associated with a position when the lid 104 is substantially parallel to, abuts, and/or is otherwise in contact with base 102 to preclude access to an interior compartment in base 102 and/or to protect items stored in an interior compartment in base 102 from intrusion by water, dust, dirt, or debris or from spilling if a bucket to which bucket seat accessory organizer 100 is being used is knocked over. In some embodiments, a closed position may be associated with a position of lid 104 when a latch 110 is engaged with a latch slot 112 formed in the base 102 to secure lid 104 relative to base 102. In other embodiments, a closed position may be associated with a position of lid 104 when it is snap fitted to base 102 or is rotatably connected to base 102 by a threaded engagement. When lid 104 is in a closed position, lid 104 (and a surrounding portion of base 102 if lid 104 is not co-extensive with an upper side of base 102) may also serve as a seating surface for a user.

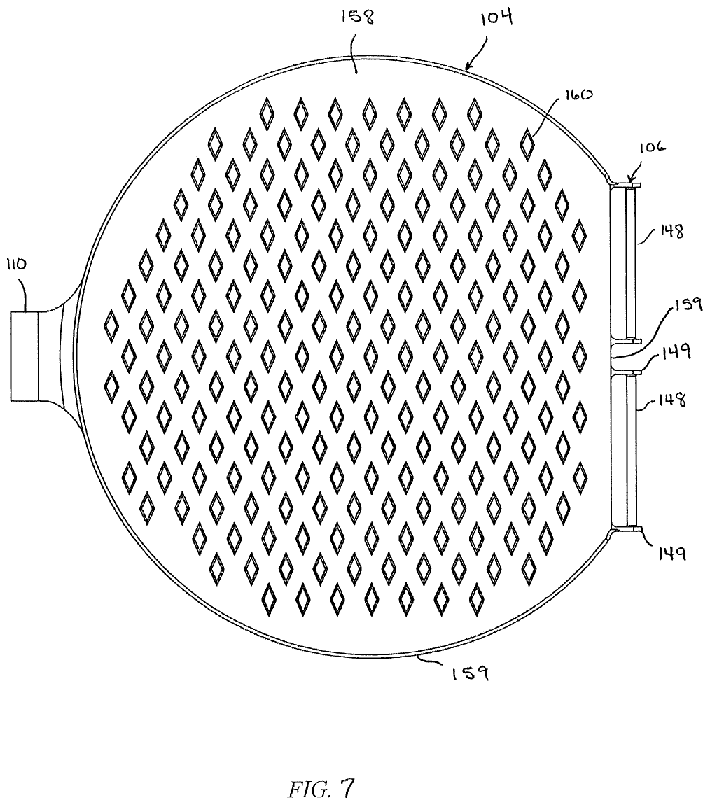

Referring to FIGS. 1 and 8, in some embodiments, bucket seat accessory organizer 100 further comprises a gasket 114 formed from an elastomeric material (e.g., rubber, silicone, etc.). Gasket 114 may be disposed between lid 104 and base 102. In some embodiments, gasket 114 is disposed in a gasket channel 154, which may be formed in or on a bottom of lid 104 (as shown in FIG. 8) or in or on an upper side of base 102. A gasket channel 154 reduces the likelihood that gasket 114 may be damaged during or become fully or partially dislodged during use of bucket seat accessory organizer 100. Alternatively, gasket 114 may be used without a gasket channel 154 by adhering gasket 114 to a surface of lid 104 (or base 102) that will mate with a surface of base 102 (or lid 104). A single gasket 114 may be used or more than one gasket 114 may be used. Gasket 114 is preferably disposed around a perimeter of lid 104 or base 102 near an outer edge of lid 104 or base 102 (or an outer edge of an interior compartment within base 102). Gasket 114 may be configured to form a fluid tight seal between base 102 and lid 104 when lid 104 is in a closed position. In some embodiments, gasket 114 may protect the contents of an interior compartment of base 102 from dirt, dust, and/or moisture during use and/or storage of bucket seat accessory organizer 100.

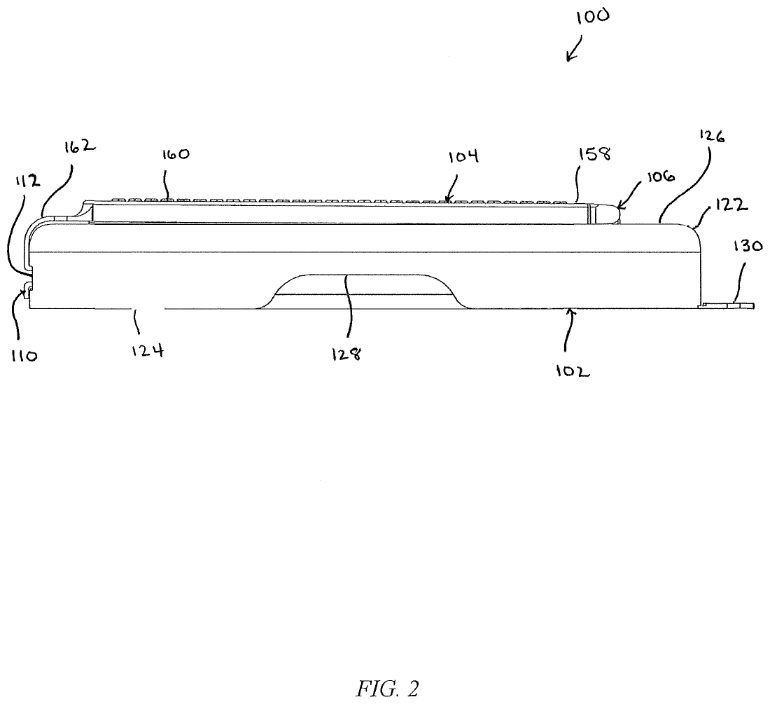

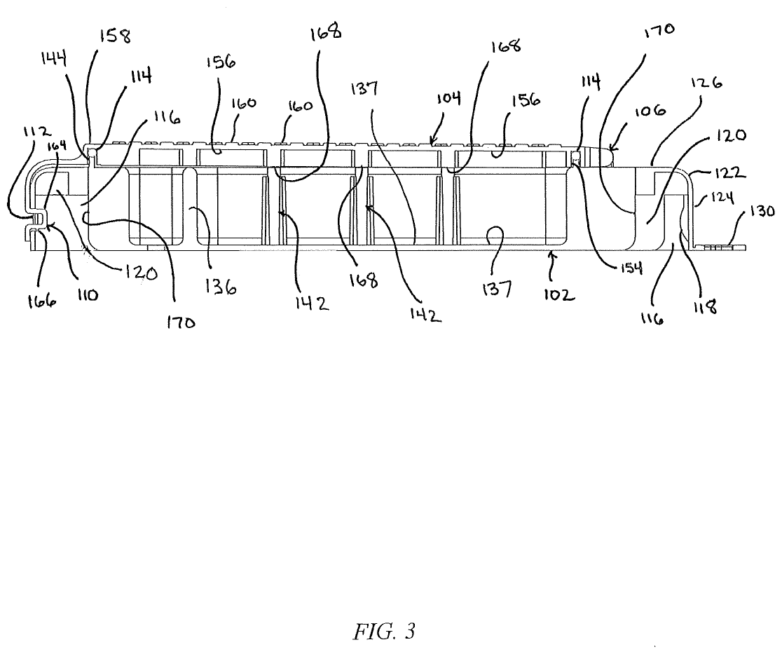

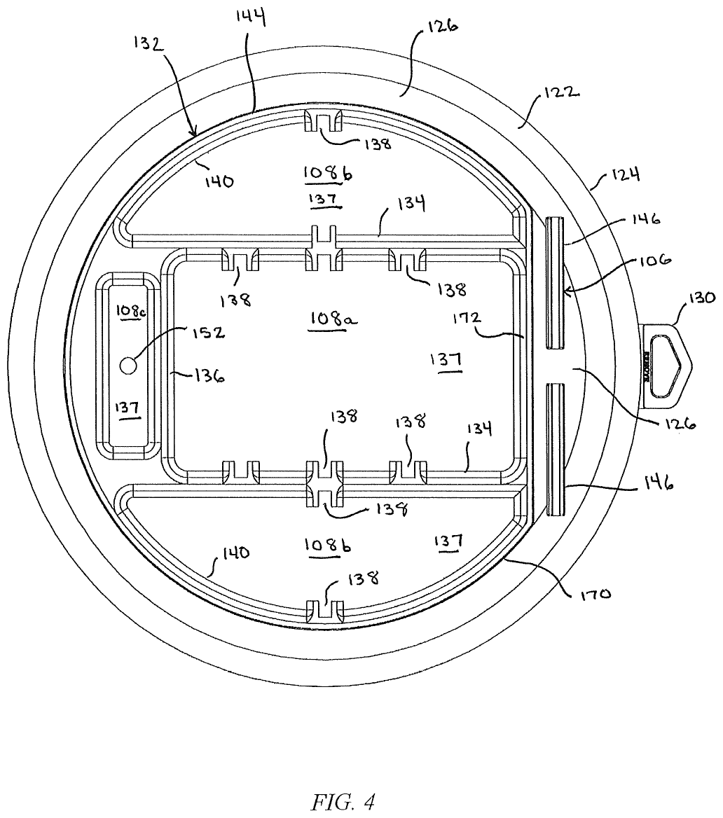

Referring to FIGS. 4 to 6, a top view, a bottom view, and a side view of a base 102 of a bucket seat accessory organizer 100 are shown according to an embodiment of the disclosure. Base 102 may generally be formed from a polymeric material, such as a high-grade polyethylene. Base 102 may generally comprise a substantially round shape and be configured to attach to a standard utility bucket, the combination of which may be referred to as a bucket assembly. In some embodiments, base 102 may comprise a channel 116 that receives an upper rim of a bucket. In some embodiments, base 102 may be configured to rotatably engage with a bucket via corresponding, mating threads. In other embodiments, base 102 may be configured for a snap fit, pry-off, or similar type engagement with a bucket. Most preferably, base 102 is configured to be selectively coupled to a bucket to close the bucket and uncoupled or removed from the bucket to allow access to an interior of the bucket. In some embodiments, a plurality of coupling tabs 118 may be disposed about channel 116 and extending inwardly from an inner surface of an outer rim or outer rim 124 of base 102. Coupling tab 118 may engage an upper rim of a bucket to securely fasten base 102 to the bucket. Coupling tab 118 may be at least partially rounded in profile, as shown in FIG. 3, and have a tapered upper portion, to prevent base 102 from unintentionally disengaging from a bucket.

In some embodiments, a plurality of reinforcing tabs 120 may be disposed about channel 116 to give base 102 additional structural rigidity. Reinforcing tabs 120 may be aligned with coupling tab 118, may be not aligned with coupling tab 118, or a combination thereof. Reinforcing tabs 120 may extend laterally from outer rim 124 to an interior sidewall 170 that defines an interior compartment or storage compartment area 132 in base 102.

Base 102 may also comprise an outer beveled or rounded shoulder 122. More specifically, base 102 may comprise the beveled or rounded shoulder 122 between the outer rim 124 and a top 126 of the base 102 to provide an ergonomic and comfortable seat surface comprising at least a portion of lid 104 and a portion of base 102. In embodiments where at least a portion of top 126 forms such a seating surface, outer beveled or rounded shoulder 122 may provide more comfort when the lid 104 is closed and the bucket seat accessory organizer 100 is used as a seat when secured to a bucket. A more squared off or angular transition between top 126 and outer rim 124 may also be used.

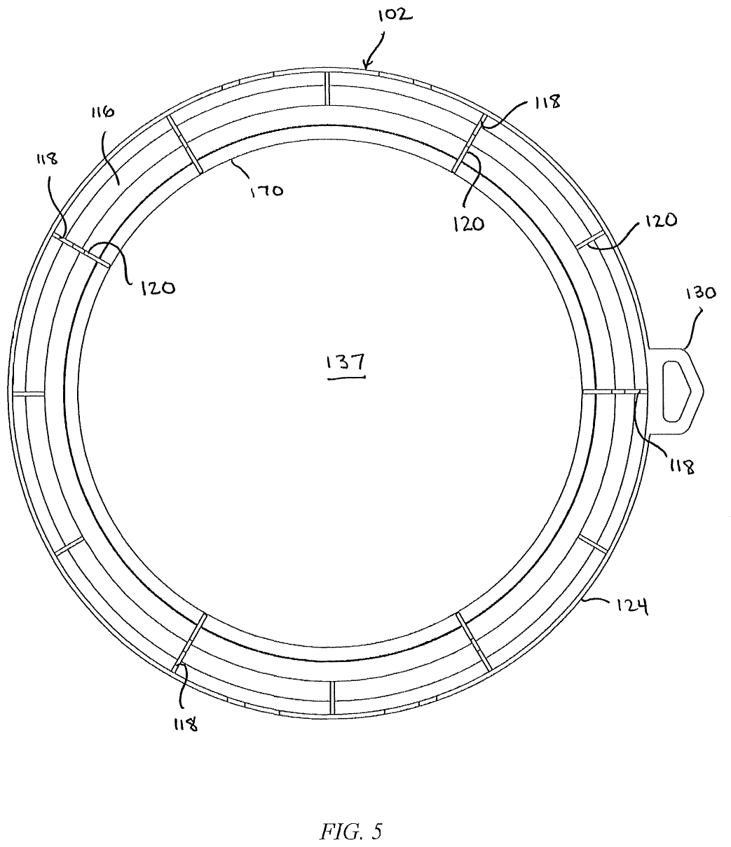

As shown in FIG. 6, in some embodiments, outer rim 124 of base 102 may comprise opposing cutouts 128 that allow a user's hand and/or fingers to enter a portion of channel 116 for easier removal of base 102 from a bucket as compared to other bucket lids. In this manner, the base 102 may be configured to “snap” onto a bucket top. Opposing cutouts 128 may also aid in removal of the base 102 from a bucket when a threaded engagement between base 102 and a bucket is used. Opposing cutouts 128 may also eliminate the need for a large carrying handle, which may interfere with use of the bucket seat accessory organizer 100 when sitting or carrying the bucket assembly. In some embodiments, outer rim 124 of base 102 may comprise a tab 130 comprising a hole that may be used to hang base 102 and/or bucket seat accessory organizer 100 for storage when not in use or on a display in a store when offered for sale. In some embodiments, tab 130 may be removable. In some embodiments, tab 130 may be perforated that allows a back-and-forth motion to weaken the material securing tab 130 to outer rim 124 until tab 130 breaks cleanly from base 102.

Base 102 may also comprise a storage compartment area 132 that may be substantially formed by a portion of interior sidewall 170 and a divider wall 172. Storage compartment area 132 may comprise a plurality of dividable storage compartments 108. Storage compartment area 132 may generally comprise a truncated circular shape that comprises a substantially circular shape (corresponding to a portion of interior sidewall 170) with one flat side (corresponding to divider wall 172). In some embodiments, storage compartment area 132 may comprise a central rectangular storage compartment 108a, two outer substantially semicircular or D-shaped storage compartments 108b that are adjacent to the central rectangular storage compartment 108a, and a smaller rectangular storage compartment 108c disposed between the two outer substantially D-shaped storage compartments 108b and at an end (in front as shown in FIG. 4) of central rectangular storage compartment 108a. However, in other embodiments, storage compartment area 132 may comprise any arrangement of dividable storage compartments 108.

Storage compartment area 132 may generally comprise one or more centrally offset fixed support walls 134 that divides the central rectangular storage compartment 108a from each of the outer substantially D-shaped storage compartments 108b. The central offset increases the structural rigidity of the base 102 as compared to other bucket lids and allows for more options in configuring individual storage areas with removable dividers as discussed below. The storage compartment area 132 may also comprise a lateral support wall 136 that divides the main rectangular storage compartment 108a from the smaller forward rectangular storage compartment 108c. The central support wall 136 may be disposed perpendicularly to the two centrally offset fixed support walls 134 to further enhance the structural rigidity of the base 102.

The outer substantially D-shaped storage compartments 108b may be formed by support walls 134 and an outer wall, which may be a portion of an interior sidewall 170 of the base 102. In other embodiments, an outer wall for outer substantially D-shaped storage compartments 108b comprises an outer wall 140 that may provide additional thickness, strength, and rigidity compared to interior sidewall 170. Outer wall 140 may abut a portion of interior sidewall 170. An added thickness for outer wall 140 also allows for divider slots 138 to be disposed in outer wall 140, as described below. A point of connection between outer wall 140 and support walls 134 may be rounded or angled, but rounded is preferred.

Central rectangular storage compartment 108a and smaller rectangular storage compartment 108c may be formed by support walls 134 and support walls 136. A rear or a forward portion of central rectangular storage compartment 108a or 108c (depending on their orientation relative to each other) may also be formed by a portion of interior sidewall 170 (for a forward portion) or divider wall 172 (for a rear portion). Use of support walls 136 may provide additional thickness, strength, and rigidity compared to interior sidewall 170 or divider wall 172 and also allows for divider slots 138 to be disposed on these walls of central rectangular storage compartment 108a and/or smaller rectangular storage compartment 108c according to some embodiments. A portion of one or more support walls 136 may abut a portion of interior sidewall 170 or divider wall 172.

Storage compartment area 132 may also comprise a bottom 137 coupled to the support walls 134, 136 that forms the bottom surface or base of each storage compartment 108. Bottom 137 may also be connected to a portion of interior sidewall 170 and divider wall 172. In some embodiments, each storage compartment 108 may comprise the same depth. However, in some embodiments, one or more storage compartments 108 may comprise two or more different depths relative to one or more other storage compartments 108. For example, in some embodiments, central rectangular storage compartment 108a may comprise a depth that is greater than a depth of the two outer substantially D-shaped storage compartments 108b and/or the forward rectangular storage compartment 108c.

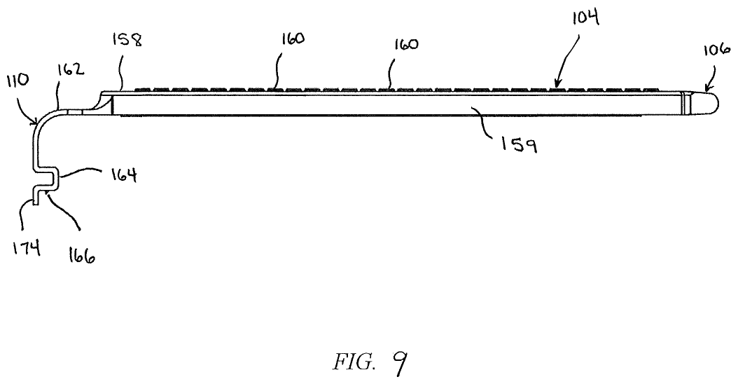

Each of central rectangular storage compartment 108a and outer substantially D-shaped storage compartments 108b, and optionally smaller rectangular storage compartment 108c, may comprise one or more divider slots 138 formed in the centrally offset fixed support walls 134 and outer walls 140. Divider slots 138 may also be disposed in support walls 136 in some embodiments. In other embodiments, portions of interior sidewall 170 and/or divider wall 172 may be configured to have divider slots 138. In some embodiments, support walls 136 do not comprise any divider slots 138. Divider slots 138 may be configured as oppositely facing pairs of slots, each disposed opposite from each other in a storage compartment 108 and configured to selectively receive a divider 142. Dividers 142 may be selectively insertable into and removable from divider slots 138 to allow for customization of the size and number of dividable storage compartments 108 in base 102. While the smaller rectangular storage compartment 108c is not depicted as comprising divider slots 138, in some embodiments, any of the storage compartments 108 may comprise divider slots 138 or may be free of divider slots 138 depending on the configuration and application of the base 102 of the bucket seat accessory organizer 100. In some embodiments, storage compartment area 132 is configured so that a distance (lateral or longitudinal) between each pair of divider slots 138 is the same as each other pair of divider slots 138, which allows dividers 142 to all be the same width (in a direction as shown in FIG. 10).

In other embodiments, storage compartment area 132 is configured so that a distance (lateral or longitudinal) between one or more pair of divider slots 138 is the same as one or more other pairs of divider slots 138, but different from at least one pair of divider slots 138. In these embodiments, there are a plurality of different dividers 142 having different widths, at least one to correspond to each distance for each of the pairs of divider slots 138. For example, central rectangular storage compartment 108a in a configuration as shown in FIG. 4 may have longitudinal divider slots 138 disposed on support walls 136 that would require a divider 142 having a greater width than a divider 142 as used for lateral divider slots 138 disposed on support walls 134.

Storage compartment area 132 may also comprise an outer ridge 144. Outer ridge 144 may extend upwardly from top 126 of base 102 in a substantially perpendicular manner. Outer ridge 144 may extend around the perimeter of storage compartment area 132 and comprise a truncated circular shape that comprises a substantially circular shape with one flat side, as shown in FIG. 1, similar to that of the storage compartment area 132. Outer ridge 144 may provide a seating surface for gasket 114 against base 102 when lid 104 is in the closed position, which may facilitate keeping the contents of storage compartments 108 free of dirt, dust, and/or moisture during use and/or storage of bucket seat accessory organizer 100. Further, in some embodiments, outer ridge 144 may be at least partially received within a gasket channel 154 of lid 104 and contact gasket 114 when gasket 114 is carried within gasket channel 154 to form a fluid tight seal between base 102 and lid 104 when lid 104 is in the closed position. In other embodiments, when gasket 114 (with or without gasket channel 154) is disposed on top 126, lid 104 may comprise an outer ridge 144 that extends downwardly to engage with gasket 114 in the same manner.

A truncated circular shape of storage compartment area 132 may be configured to maximize an amount of storage space in base 102 while still providing space for a hinge rod retainer 146 in embodiments where lid 104 is coupled to base 102 by a hinge or hinges. A hinge rod retainer 146 or two hinge rod retainers 146 may be used depending on the number of hinges. In a dual hinge assembly 106 embodiment, dual hinge assembly 106 may comprise two hinge rod retainers 146, hinge rods 148, and a hinge rod supports 149. Hinge rod retainers 146 may extend upwards from top 126 of base 102 and comprise a substantially semi-closed C-shaped cross-section (as shown in an end view in FIG. 6). Hinge rod retainers 146 may be configured to receive and securely retain hinge rods 148 of lid 104 within the C-shaped cross-section, while allowing hinge rods 148 to freely rotate or pivot within hinge rod retainers 146. This configuration allows lid 104 to freely pivot with respect to base 102 between open and closed positions while being securely coupled to base 102. Collectively, each hinge rod retainer 146 and associated hinge rod 148 may form a hinge of dual hinge assembly 106. Providing dual hinges in dual hinge assembly 106 may allow lid 104 to functionally open and close while remaining attached to the base 102 in the event one of the hinges is broken or otherwise damaged. Hinges may allow for at least 180° of movement of lid 104 between a closed position and a fully open position in some embodiments. In other embodiments, hinges may limit a range of pivoting of lid 104 between 0° (in a closed position) to around 90°, or 0 to around 120°, or 0 to around 150°. Preferably, lid 104 is disposed at an angle of least 100° when fully opened to prevent lid 104 from inadvertently falling closed while a user is accessing storage compartment area 132. Further, it will be appreciated that dual hinge assembly 106 may be positioned on the same side as tab 130, so that gravity keeps lid 104 in a substantially closed position when the bucket seat accessory organizer 100 is hung by tab 130 for storage or displayed in a store for sale. Hinge rod retainers 146 may be positioned inwardly from outer beveled or rounded shoulder 122 on top 126. There may be a gap or space between an inner side of hinge rod retainers 146 and outer ridge 144, which allows for use of optional gasket channel 154 with a portion of gasket channel 154 fitting within the gap or space.

In other embodiments, a flexible material, such as plastic, rubber, or strapping, may be used to couple lid 104 to base 102 while still allowing lid 104 to be movable between an open and a closed position. A portion of flexible material may be adhered to, formed with, or otherwise connected to each of lid 104 and base 102 at or near a rear side of each. Flexible materials would allow a point of coupling to be placed on top 126 or on outer rim 124.

Base 102 may also comprise a latch slot 112. Latch slot 112 may comprise a substantially rectangular shape and may be formed in the outer rim 124 of the base, as shown in FIG. 3. Latch slot 112 may be configured to receive and retain latch 110 of lid 104 when lid 104 is in a closed position and to retain lid 104 in a closed position until latch 110 is released from latch slot 112 by a user. A bottom portion of latch 110 may be selectively manipulated to bend or flex the latch 110 to disengage latch 110 from latch slot 112 when it is desired to access storage compartment area 132 of base 102, as further described below.

In some embodiments, one or more of storage compartments 108 may comprise a weep hole 152 or a plurality of weep holes 152 that allow dirt, debris, and/or moisture to drain from the storage compartment 108 into the bucket when bucket seat accessory organizer 100 is secured to the bucket.

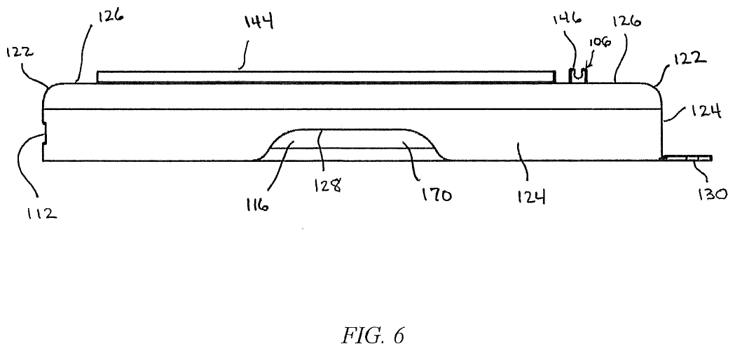

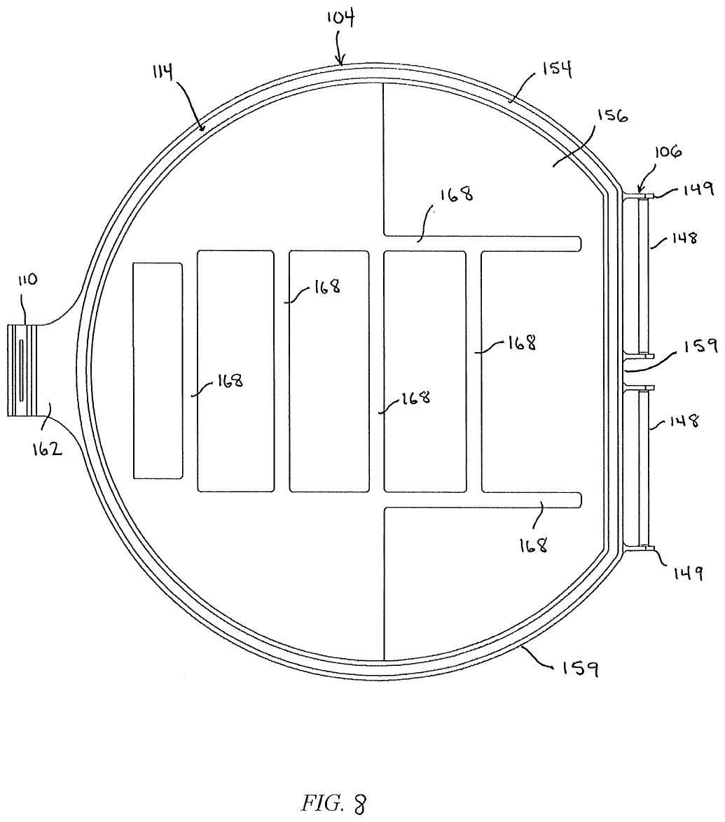

Referring to FIGS. 7 to 9, a top view, a bottom view, and a side view of a lid 104 according to an embodiment of the disclosure are shown. Lid 104 may generally be formed from a polymeric material. In some embodiments, lid 104 may be formed from a transparent or translucent polymeric material, such as a polycarbonate or acrylic, that allows the contents of storage compartments 108 to be at least partially viewed through lid 104. In some embodiments, lid 104 may be formed from a UV-resistant material. In some cases, when a bucket seat accessory organizer 100 is used in outdoor conditions, it may be subjected to long hours of sunlight that may degrade material used for lid 104. Use of UV-resistant material aids in prolonging the life span of lid 104 to provide a smooth (non-cracked) seating surface and to protect contents in storage compartment area 132 when lid 104 is in a closed position. Lid 104 may generally comprise a truncated circular shape that comprises a substantially circular shape with one flat side that is substantially similar to the shape of storage compartment area 132. Lid 104 may be slightly or substantially larger than the storage compartment area 132, to allow for overlap of gasket 114 and outer ridge 144 or to allow outer ridge 144 to be received within the gasket channel 154 when lid 104 is in the closed position.

Lid 104 may also comprise a top surface 158 opposite the bottom surface 156. A plurality of raised protrusions 160 may be disposed across and extend upwardly from top surface 158. Each protrusion may be the same shape, such as a diamond shaped as shown in FIG. 7 (not shown in FIG. 8 for clarity), or there may be multiple different shapes or lines. Protrusions 160 may provide enhanced friction with the pants or legs of a user when bucket seat accessory organizer 100 is used as a seat or the foot or footwear of a user if/when bucket seat accessory organizer 100 is used as a step stool or a footrest. Additionally, protrusions 160 may serve as a decorative element for the lid 104, forming a pattern on top surface 158 or depicting a decorative element or a logo (such as a sports team logo).

Lid 104 may also comprise hinge rods 148 and hinge rod supports 149 of dual hinge assembly 106. The hinge rod supports 149 and hinge rods 148 may extend from lid 104, preferably from an outer sidewall 159, and may be configured to allow hinge rods 148 to engage with hinge rod retainers 146 of base 102. Dual hinge assembly 106 may be configured to allow hinge rods 148 to be relatively fixed to hinge rod supports 149 while hinge rods 148 freely pivot within the hinge rod retainers 146. Alternatively, dual hinge assembly 106 may be configured to allow hinge rods 148 to be relatively fixed in hinge rod retainers 146 while hinge rod supports 149 are configured to freely pivot around hinge rods 148. Single hinge embodiments may be similarly configured.

Lid 104 may also comprise a latch 110. In some embodiments, latch 110 is disposed on a front end of lid 104 opposite hinge rods 148. Latch 110 may be disposed centrally between dual hinge assembly 106 when two hinges are used. Latch 110 may comprise a single latch or two latches 110 may be used. Latch 110 may extend forwardly from outer sidewall 159. Latch 110 may comprise a beveled or rounded portion 162 that curves downwardly to a an inwardly extending U-shaped latch catch 164 that is configured to engage latch slot 112 formed in base 102 when the lid 104 is in the closed position. Latch catch 164 may comprise a substantially rectangular shape and be sized and shaped complementary to latch slot 112 to reduce movement of lid 104 with respect to base 102 and to preferably ensure a fluid tight seal with base 102 when lid 104 is in the closed position. In some embodiments, latch 110 may also comprise a triangular nub 166 that extends downwardly from U-shaped latch catch 164. Triangular nub 166 may be configured to engage outer rim 124 of base 102 to secure lid 104 in the closed position and/or retain latch catch 164 in latch slot 112 formed in base 102 when lid 104 is in the closed position. Latch 110 may also comprise a finger tab 174 extending downwardly from latch catch 164. Finger tab 174 may aid in a user being able to pull on latch 110 to disengage latch catch 164 from latch slot 112 when lid 104 is to be opened. In some embodiments, there is a gap between finger tab 174 and interior sidewall 170 of base 102. In other embodiments, finger tab 174 substantially abuts interior sidewall 170.

Lid 104 may also comprise a plurality of ridges 168. Ridges 168 may extend downwardly from bottom surface 156 of the lid 104. In some embodiments, ridges 168 may be aligned with support walls 134, 136 or ridges 168 may be configured to align with selectively insertable and removable dividers 142 or both. When lid 104 is in the closed position, ridges 168 may contact support walls 134, 136 and/or any dividers 142 installed in divider slots 138. Ridges 168 aid in keeping contents of each storage compartment 108 segregated when lid 104 is in the closed position and in response to the bucket seat accessory organizer 100 and/or a bucket assembly comprising bucket seat accessory organizer 100 becoming turned over, jostled, or otherwise manipulated that would tend to disrupt the location of the contents of storage compartments 108. Thus, the ridges 168 cooperate with the support walls 134, 136 and/or any dividers 142 installed in divider slots 138 to retain the contents of each storage compartment 108 in their respective storage compartment 108. Further, ridges 168 also allow for additional depth of each storage compartment 108, effectively extending a height of support walls 134, 136 and/or dividers 142, to allow for oversized contents that extend above support walls 134, 136 and/or dividers 142 to be carried by bucket seat accessory organizer 100.

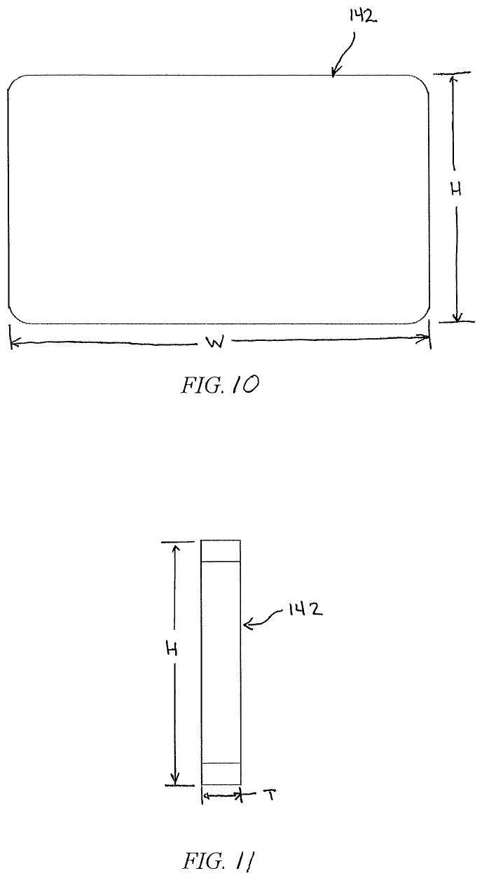

Referring to FIGS. 10 and 11, a front view and a side view of a divider 142 according to an embodiment of the disclosure are shown. Dividers 142 may be selectively insertable into and removable from divider slots 138 to allow for customization of the size and number of dividable storage compartments 108 in base 102. Dividers 142 may comprise a height (“H”) that is substantially similar to a height of support walls 134, 136. Having a substantially similar height allows ridges 168 to be configured of similar height to contact both dividers 142 (if used) and support walls 134, 136 in embodiments where ridges 168 are aligned with both when lid 104 is in the closed position to retain the contents of each storage compartment 108 in their respective storage compartment 108. Differing heights for dividers 142 and support walls 134, 136 may also be used with corresponding differences in heights of aligned ridges 168 in other embodiments. In some embodiments, dividers 142 may comprise a substantially rectangular shape and have slightly beveled or rounded corners.

Further, in some embodiments, depending on the configuration of storage compartments 108 in storage compartment area 132, one or more dividers 142 may comprise different sizes (height, width, and/or thickness) relative to one or more other dividers 142. For example, in the embodiment shown in FIGS. 1 and 4, central rectangular storage compartment 108a may comprise dividers 142 having a larger width (“W”) than dividers 142 used in outer substantially semicircular or D-shaped storage compartments 108b that are adjacent to central rectangular storage compartment 108a. In some embodiments, dividers 142 may all have the same height (in a direction as shown in FIG. 10) as other dividers 142, particularly if a depth of all storage compartments 108 is the same, or different heights so that dividers 142 are specifically usable with only certain storage compartments 108. Additionally, when different sizes in height and/or width of dividers 142 are used, differences in thickness (“T”) may also be used, with corresponding changes in the space provided by divider slots 138, to allow a particular divider 142 to be used only with one or more particular divider slots 138 for the particular storage compartment 108 to which the sizes correspond. Having a different thickness may aid a user is aligning a divider 142 with a storage compartment 108 for which it is properly sized by height and/or width, as some dividers 142 would be too thick to insert into specific divider slots 138. In still other embodiments where different sizes are used, various components may have a visual identifier, such as a color or texture or pattern to aid in aligning dividers 142 with divider slots 138 for a particular storage compartment 108 that corresponds in size to a particular divider 142. For example, narrower dividers 142 usable with outer substantially D-shaped storage compartments 108b in an embodiment as depicted in FIG. 4 may be colored green and divider slots 138 in outer substantially D-shaped storage compartments 108b may similarly be colored green and/or an interior surface or portion of outer substantially D-shaped storage compartments 108b may be colored green. Wider dividers 142 usable with central rectangular storage compartment 108a in an embodiment as depicted in FIG. 4 may be colored blue and divider slots 138 in central rectangular storage compartment 108a may similarly be colored blue and/or an interior surface or portion of central rectangular storage compartment 108a may be colored blue. However, it will be appreciated that embodiments of a bucket seat accessory organizer 100 may comprise any number or size or arrangement of storage compartments 108, divider slots 138, and dividers 142 depending on the application and size of the bucket to which the bucket seat accessory organizer 100 is intended to attach.

### EXAMPLES

It will be appreciated that a bucket seat accessory organizer 100 disclosed herein may include one or more of the following Examples:

Example 1. A bucket seat accessory organizer, comprising: a base configured to fasten to a utility bucket, the base comprising: an outer rim comprising a latch slot; a top coupled to the outer rim; and a storage compartment area disposed in the top and comprising a plurality of dividable storage compartments and a raised outer ridge extending around a perimeter of the storage compartment; and a lid rotatably coupled to the base by a hinge assembly that allows the lid to rotate relative to the base between an open position and a closed position, the lid comprising: a latch configured to engage the latch slot to secure the lid in the closed position; a gasket channel disposed about a perimeter of and extending from a lower surface of the lid; and a gasket disposed within the gasket channel and configured to form a fluid tight seal between the raised outer ridge of the base and the lid when the lid is in the closed position.

Example 2. The bucket seat accessory organizer of Example 1, wherein the base comprises a channel that receives an upper rim of the utility bucket.

Example 3. The bucket seat accessory organizer of any of the preceding Examples, wherein the channel comprises a plurality of rounded tabs extending inwardly from an inner portion of the outer rim of the base, and wherein the plurality of rounded tabs are configured to engage the upper rim of the utility bucket to securely fasten the base to the utility bucket.

Example 4. The bucket seat accessory organizer of any of the preceding Examples, wherein the channel comprises a plurality of reinforcing tabs that provide structural rigidity to the base.

Example 5. The bucket seat accessory organizer of any of the preceding Examples, wherein the top is coupled to the outer rim by a beveled or rounded edge.

Example 6. The bucket seat accessory organizer of any of the preceding Examples, wherein the beveled or rounded edge is configured to provide comfort to a user when the lid is in the closed position and the bucket seat accessory organizer is used as a seat.

Example 7. The bucket seat accessory organizer of any of the preceding Examples, wherein the outer rim comprises opposing cutouts that provide access for a user's hands or fingers to enter a portion of the channel for removal of the base from the utility bucket.

Example 8. The bucket seat accessory organizer of any of the preceding Examples, wherein the outer rim comprises a tab comprising a hole configured to hang the bucket seat accessory organizer.

Example 9. The bucket seat accessory organizer of any of the preceding Examples, wherein the tab is selectively removable.

Example 10. The bucket seat accessory organizer of any of the preceding Examples, wherein the storage compartment area comprises a truncated circular shape that comprises a substantially circular shape having one flat side.

Example 11. The bucket seat accessory organizer of any of the preceding Examples, wherein the storage compartment area comprises a central rectangular storage compartment, two outer substantially D-shaped storage compartments disposed adjacent to the central rectangular storage compartment, and a smaller rectangular storage compartment disposed between the two outer substantially D-shaped storage compartments and in front of the central rectangular storage compartment.

Example 12. The bucket seat accessory organizer of any of the preceding Examples, wherein the storage compartment area comprises a centrally offset fixed support wall that divides the central rectangular storage compartment from each of the two outer substantially D-shaped storage compartments.

Example 13. The bucket seat accessory organizer of any of the preceding Examples, wherein the centrally offset fixed support walls increase the structural rigidity of the base.

Example 14. The bucket seat accessory organizer of any of the preceding Examples, wherein the storage compartment area comprises a central support wall that divides the central rectangular storage compartment from the smaller rectangular storage compartment.

Example 15. The bucket seat accessory organizer of any of the preceding Examples, wherein the central support wall is disposed perpendicularly to the two centrally offset fixed support walls.

Example 16. The bucket seat accessory organizer of any of the preceding Examples, wherein the storage compartment area comprises a bottom coupled to each of the two centrally offset fixed support walls and the central support wall to form a bottom surface of each of the dividable storage compartments.

Example 17. The bucket seat accessory organizer of any of the preceding Examples, wherein the dividable storage compartments comprise a substantially similar depth.

Example 18. The bucket seat accessory organizer of any of the preceding Examples, wherein at least one of the dividable storage compartments comprises a different depth.

Example 19. The bucket seat accessory organizer of any of the preceding Examples, wherein each of the dividable storage compartments comprises at least one pair of opposing divider slots configured to selectively receive a divider.

Example 20. The bucket seat accessory organizer of any of the preceding Examples, further comprising: at least one divider selectively inserted into at least one pair of the opposing divider slots formed in the dividable storage compartments.

Example 21. The bucket seat accessory organizer of any of the preceding Examples, wherein the at least one divider comprises a height that is substantially similar to a depth of the dividable storage compartment to retain the contents of the dividable storage compartment in their respective storage compartment.

Example 22. The bucket seat accessory organizer of any of the preceding Examples, wherein the raised outer ridge extends from the top of the base substantially perpendicularly.

Example 23. The bucket seat accessory organizer of any of the preceding Examples, wherein the raised outer ridge provides a seating surface for the gasket against the base when the lid is in the closed position.

Example 24. The bucket seat accessory organizer of any of the preceding Examples, wherein the raised outer ridge is at least partially received within a gasket channel of the lid when the lid is in the closed position.

Example 25. The bucket seat accessory organizer of any of the preceding Examples, wherein the base is formed from a polymeric material.

Example 26. The bucket seat accessory organizer of any of the preceding Examples, wherein the lid is formed from a transparent or translucent polymeric material.

Example 27. The bucket seat accessory organizer of any of the preceding Examples, wherein the lid is formed from a UV-resistant material.

Example 28. The bucket seat accessory organizer of any of the preceding Examples, wherein the lid comprises a plurality of raised diamond-shaped protrusions disposed in a pattern across a top surface of the lid.

Example 29. The bucket seat accessory organizer of any of the preceding Examples, wherein the gasket is formed from an elastomeric material.

Example 30. The bucket seat accessory organizer of any of the preceding Examples, wherein the lid comprises a plurality of ridges extending from the lower surface of the lid.

Example 31. The bucket seat accessory organizer of any of the preceding Examples, wherein the plurality of ridges are aligned with each of a plurality of support walls formed in the base.

Example 32. The bucket seat accessory organizer of any of the preceding Examples, wherein the plurality of ridges are aligned with each of a plurality of selectively insertable and removable dividers.

Example 33. The bucket seat accessory organizer of any of the preceding Examples, wherein the plurality of ridges cooperate with the plurality of support walls formed in the base and the dividers installed in the dividable storage compartments to retain contents in each of the dividable storage compartments in their respective storage compartment.

Example 34. The bucket seat accessory organizer of any of the preceding Examples, wherein the hinge assembly comprises a dual hinge assembly.

Example 35. The bucket seat accessory organizer of any of the preceding Examples, wherein the base comprises two axially aligned hinge rod retainers comprising a substantially semi-closed C-shaped cross-section, and wherein the two axially aligned hinge rod retainers are configured to receive and securely retain two hinge rods of the lid while allowing the two hinge rods to freely rotate within the hinge rod retainers to rotate the lid between the open position and the closed position.

Example 36. The bucket seat accessory organizer of any of the preceding Examples, wherein the open position is associated with any position in which the lid is rotated away from the base to allow access to contents stored in the plurality of dividable storage compartments, and wherein the closed position is associated with a position when the latch engages the latch slot and the gasket forms a fluid tight seal between the base and lid.

Example 37. The bucket seat accessory organizer of any of the preceding Examples, wherein the latch comprises a beveled or rounded portion that curves downwardly to an inwardly extending U-shaped latch catch that is configured to engage the latch slot formed in the base to retain the lid in the closed position.

Example 38. The bucket seat accessory organizer of any of the preceding Examples, wherein the U-shaped latch catch comprises a substantially rectangular shape and is shaped complementary to the latch slot to reduce movement of the lid with respect to the base and ensure a fluid tight seal between the lid and the base when the lid is in the closed position.

Example 39. The bucket seat accessory organizer of any of the preceding Examples, wherein the latch comprises a triangular nub that extends downwardly from the U-shaped latch catch and that is configured to engage an outer rim of the base to retain the latch catch in the latch slot when the lid is in the closed position.

Example 40. The bucket seat accessory organizer of any of the preceding Examples, wherein the bucket seat accessory organizer is secured over an opening in a top of the standard utility bucket to provide a storage assembly and seat combination for the standard utility bucket.

Example 41. A bucket assembly, comprising: a utility bucket; and a bucket seat accessory organizer coupled to the bucket, the bucket seat accessory organizer comprising: a base configured to fasten to a utility bucket, the base comprising: an outer rim comprising a latch slot; a top coupled to the outer rim; and a storage compartment area disposed in the top and comprising a plurality of dividable storage compartments and a raised outer ridge extending around a perimeter of the storage compartment; and a lid rotatably coupled to the base by a hinge assembly that allows the lid to rotate relative to the base between an open position and a closed position, the lid comprising: a latch configured to engage the latch slot to secure the lid in the closed position; a gasket channel disposed about a perimeter of and extending from a lower surface of the lid; and a gasket disposed within the gasket channel and configured to form a fluid tight seal between the raised outer ridge of the base and the lid when the lid is in the closed position.

Example 42. The bucket assembly of any of the preceding Examples, wherein the base comprises a channel that receives an upper rim of the utility bucket.

Example 43. The bucket assembly of any of the preceding Examples, wherein the channel comprises a plurality of rounded tabs extending inwardly from an inner portion of the outer rim of the base, and wherein the plurality of rounded tabs are configured to engage the upper rim of the utility bucket to securely fasten the base to the utility bucket.

Example 44. The bucket assembly of any of the preceding Examples, wherein the channel comprises a plurality of reinforcing tabs that provide structural rigidity to the base.

Example 45. The bucket assembly of any of the preceding Examples, wherein the top is coupled to the outer rim by a beveled or rounded edge.

Example 46. The bucket assembly of any of the preceding Examples, wherein the beveled or rounded edge is configured to provide comfort to a user when the lid is in the closed position and the bucket seat accessory organizer is used as a seat.

Example 47. The bucket assembly of any of the preceding Examples, wherein the outer rim comprises opposing cutouts that provide access for a user's hands or fingers to enter a portion of the channel for removal of the base from the utility bucket.

Example 48. The bucket assembly of any of the preceding Examples, wherein the outer rim comprises a tab comprising a hole configured to hang the bucket seat accessory organizer.

Example 49. The bucket assembly of any of the preceding Examples, wherein the tab is selectively removable.

Example 50. The bucket assembly of any of the preceding Examples, wherein the storage compartment area comprises a truncated circular shape that comprises a substantially circular shape having one flat side.

Example 51. The bucket assembly of any of the preceding Examples, wherein the storage compartment area comprises a central rectangular storage compartment, two outer substantially D-shaped storage compartments disposed adjacent to the central rectangular storage compartment, and a smaller rectangular storage compartment disposed between the two outer substantially D-shaped storage compartments and in front of the central rectangular storage compartment.

Example 52. The bucket assembly of any of the preceding Examples, wherein the storage compartment area comprises a centrally offset fixed support wall that divides the central rectangular storage compartment from each of the two outer substantially D-shaped storage compartments.

Example 53. The bucket assembly of any of the preceding Examples, wherein the centrally offset fixed support walls increase the structural rigidity of the base.

Example 54. The bucket assembly of any of the preceding Examples, wherein the storage compartment area comprises a central support wall that divides the central rectangular storage compartment from the smaller rectangular storage compartment.

Example 55. The bucket assembly of any of the preceding Examples, wherein the central support wall is disposed perpendicularly to the two centrally offset fixed support walls.

Example 56. The bucket assembly of any of the preceding Examples, wherein the storage compartment area comprises a bottom coupled to each of the two centrally offset fixed support walls and the central support wall to form a bottom surface of each of the dividable storage compartments.

Example 57. The bucket assembly of any of the preceding Examples, wherein the dividable storage compartments comprise a substantially similar depth.

Example 58. The bucket assembly of any of the preceding Examples, wherein at least one of the dividable storage compartments comprises a different depth.

Example 59. The bucket assembly of any of the preceding Examples, wherein each of the dividable storage compartments comprises at least one pair of opposing divider slots configured to selectively receive a divider.

Example 60. The bucket assembly of any of the preceding Examples, further comprising: at least one divider selectively inserted into at least one pair of the opposing divider slots formed in the dividable storage compartments.

Example 61. The bucket assembly of any of the preceding Examples, wherein the at least one divider comprises a height that is substantially similar to a depth of the dividable storage compartment to retain the contents of the dividable storage compartment in their respective storage compartment.

Example 62. The bucket assembly of any of the preceding Examples, wherein the raised outer ridge extends from the top of the base substantially perpendicularly.

Example 63. The bucket assembly of any of the preceding Examples, wherein the raised outer ridge provides a seating surface for the gasket against the base when the lid is in the closed position.

Example 64. The bucket assembly of any of the preceding Examples, wherein the raised outer ridge is at least partially received within a gasket channel of the lid when the lid is in the closed position.

Example 65. The bucket assembly of any of the preceding Examples, wherein the base is formed from a polymeric material.

Example 66. The bucket assembly of any of the preceding Examples, wherein the lid is formed from a transparent or translucent polymeric material.

Example 67. The bucket assembly of any of the preceding Examples, wherein the lid is formed from a UV-resistant material.

Example 68. The bucket assembly of any of the preceding Examples, wherein the lid comprises a plurality of raised diamond-shaped protrusions disposed in a pattern across a top surface of the lid.

Example 69. The bucket assembly of any of the preceding Examples, wherein the gasket is formed from an elastomeric material.

Example 70. The bucket assembly of any of the preceding Examples, wherein the lid comprises a plurality of ridges extending from the lower surface of the lid.

Example 71. The bucket assembly of any of the preceding Examples, wherein the plurality of ridges are aligned with each of a plurality of support walls formed in the base.

Example 72. The bucket assembly of any of the preceding Examples, wherein the plurality of ridges are aligned with each of a plurality of selectively insertable and removable dividers.

Example 73. The bucket assembly of any of the preceding Examples, wherein the plurality of ridges cooperate with the plurality of support walls formed in the base and the dividers installed in the dividable storage compartments to retain contents in each of the dividable storage compartments in their respective storage compartment.

Example 74. The bucket assembly of any of the preceding Examples, wherein the hinge assembly comprises a dual hinge assembly.

Example 75. The bucket assembly of any of the preceding Examples, wherein the base comprises two axially aligned hinge rod retainers comprising a substantially semi-closed C-shaped cross-section, and wherein the two axially aligned hinge rod retainers are configured to receive and securely retain two hinge rods of the lid while allowing the two hinge rods to freely rotate within the hinge rod retainers to rotate the lid between the open position and the closed position.

Example 76. The bucket assembly of any of the preceding Examples, wherein the open position is associated with any position in which the lid is rotated away from the base to allow access to contents stored in the plurality of dividable storage compartments, and wherein the closed position is associated with a position when the latch engages the latch slot and the gasket forms a fluid tight seal between the base and lid.

Example 77. The bucket assembly of any of the preceding Examples, wherein the latch comprises a beveled or rounded portion that curves downwardly to an inwardly extending U-shaped latch catch that is configured to engage the latch slot formed in the base to retain the lid in the closed position.

Example 78. The bucket assembly of any of the preceding Examples, wherein the U-shaped latch catch comprises a substantially rectangular shape and is shaped complementary to the latch slot to reduce movement of the lid with respect to the base and ensure a fluid tight seal between the lid and the base when the lid is in the closed position.

Example 79. The bucket assembly of any of the preceding Examples, wherein the latch comprises a triangular nub that extends downwardly from the U-shaped latch catch and that is configured to engage an outer rim of the base to retain the latch catch in the latch slot when the lid is in the closed position.

Example 80. The bucket assembly of any of the preceding Examples, wherein the bucket seat accessory organizer is secured over an opening in a top of the standard utility bucket to provide a storage assembly and seat combination for the standard utility bucket.

References herein to forward, front, and the like generally refer to a direction from tab 130 toward latch 110 and references to rearward, rear, and the like generally refer to a direction from latch 110 toward tab 130, both when lid 104 is in a closed position (although embodiments of a bucket seat accessory organizer 100 according to the disclosure do not necessarily require these specific components). Similarly, longitudinal generally refers to a direction oriented along or extending with a front/rear direction and lateral generally refers to a direction oriented along or extending with a direction substantially perpendicular to a front/rear direction (such as from one opposing cutout 128 to another opposing cutout 128). References herein to up, upper, upward, top and the like generally refer to a direction from base 102 toward lid 104 as shown in FIG. 1 and references to down, downward, bottom, lower, and the like generally refer to a direction from lid 104 toward base 102 as shown in FIG. 1.

Any components or features of one embodiment or example or a preferred embodiment or preferred example herein may be used with any other components or features of other embodiments or examples even if not specifically described with respect to that embodiment, unless such combination is explicitly excluded herein. Any component or feature described as excluded with any particular embodiment or example herein may similarly be excluded with any other embodiment or example herein even if not specifically described with such embodiment or example.

All numerical values for amounts, sizes, ratios, and other numeric values herein described as a range specifically include any individual value or ratio within such ranges and any and all subset combinations within ranges, including subsets that overlap from one range embodiment (such as a preferred range) to another range embodiment (such as a more preferred range) and even if the specific subset of the range is not specifically described herein. References to “about” or “around” with respect to numerical values generally mean+/−1 for values expressed as whole numbers (without a decimal, e.g., around 5 inches means 4-6 inches and around 50% means 49-51%); +/−0.1 for values expressed with a single decimal place; +/−0.01 for values expressed with two decimal place, and +/−0.001 for values expressed to three or more decimal places (for example, around 5.1 inches means 4.9-5.1 inches).

In the foregoing specification, the concepts have been described with reference to specific embodiments. However, those of ordinary skill in the art appreciate that various modifications and changes can be made without departing from the scope of the invention as set forth in the claims below. Other examples that occur to those skilled in the art are intended to be within the scope of the claims if they have structural elements that do not differ from the literal language of the claims, or if they include equivalent structural elements with insubstantial differences from the literal languages of the claims. Accordingly, the specification and figures are to be regarded in an illustrative rather than in a restrictive sense, and all such modifications are intended to be included within the scope of the invention.

Benefits, other advantages, and solutions to problems have been described above with respect to one or more specific embodiments. After reading the specification, those of ordinary skill in the art will appreciate that certain features that are, for clarity, described herein in the context of separate embodiments, may also be provided in combination in a single embodiment. Conversely, various features that are, for brevity, described in the context of a single embodiment, may also be provided separately or in any sub-combination. Further, references to values stated in ranges include each and every value within that range and include sub-ranges that overlap from one preferred range to another preferred range.

What is claimed is:

1. A bucket seat accessory organizer, comprising:
a base configured to fasten to a utility bucket, the base comprising:
an outer rim comprising a latch slot;
a top coupled to the outer rim; and
a storage compartment area disposed in the top and comprising a plurality of dividable storage compartments and a raised outer ridge extending around a perimeter of the storage compartment; and
a lid rotatably coupled to the base by a hinge assembly that allows the lid to rotate relative to the base between an open position and a closed position, the lid comprising:
a latch configured to engage the latch slot to secure the lid in the closed position;
a gasket channel disposed about a perimeter of and extending from a lower surface of the lid; and
a gasket disposed within the gasket channel and configured to form a fluid tight seal between the raised outer ridge of the base and the lid when the lid is in the closed position.

2. The bucket seat accessory organizer of claim 1, wherein the base comprises a channel that receives an upper rim of the utility bucket.

3. The bucket seat accessory organizer of claim 2, wherein the channel comprises a plurality of rounded tabs extending inwardly from an inner portion of the outer rim of the base, and wherein the plurality of rounded tabs are configured to engage the upper rim of the utility bucket to securely fasten the base to the utility bucket.

4. The bucket seat accessory organizer of claim 3, wherein the channel comprises a plurality of reinforcing tabs that provide structural rigidity to the base.

5. The bucket seat accessory organizer of claim 1, wherein the top is coupled to the outer rim by a beveled or rounded edge.

6. The bucket seat accessory organizer of claim 2, wherein the outer rim comprises opposing cutouts that provide access for a user's hands or fingers to enter a portion of the channel for removal of the base from the utility bucket.

7. The bucket seat accessory organizer of claim 1, wherein the outer rim comprises a tab comprising a hole configured to hang the bucket seat accessory organizer.

8. The bucket seat accessory organizer of claim 1, wherein the storage compartment area comprises a truncated circular shape that comprises a substantially circular shape having one flat side.

9. The bucket seat accessory organizer of claim 8, wherein the storage compartment area comprises a central rectangular storage compartment, two outer substantially D-shaped storage compartments disposed adjacent to the central rectangular storage compartment, and a smaller rectangular storage compartment disposed between the two outer substantially D-shaped storage compartments and in front of the central rectangular storage compartment.

10. The bucket seat accessory organizer of claim 9, wherein the storage compartment area comprises a centrally offset fixed support wall that divides the central rectangular storage compartment from each of the two outer substantially D-shaped storage compartments.

11. The bucket seat accessory organizer of claim 10, wherein the storage compartment area comprises a central support wall that divides the central rectangular storage compartment from the smaller rectangular storage compartment.

12. The bucket seat accessory organizer of claim 11, wherein the central support wall is disposed perpendicularly to the two centrally offset fixed support walls.

13. The bucket seat accessory organizer of claim 12, wherein the storage compartment area comprises a bottom coupled to each of the two centrally offset fixed support walls and the central support wall to form a bottom surface of each of the dividable storage compartments.

14. The bucket seat accessory organizer of claim 13, wherein at least one of the dividable storage compartments comprises a different depth.

15. The bucket seat accessory organizer of claim 1, further comprising a plurality of dividers; wherein each of the dividable storage compartments comprises at least one pair of opposing divider slots configured to selectively receive one of the plurality of dividers.

16. The bucket seat accessory organizer of claim 15, wherein the at least one of the plurality of dividers comprises a height that is substantially similar to a depth of the dividable storage compartment to retain the contents of the dividable storage compartment in their respective storage compartment.

17. The bucket seat accessory organizer of claim 1, wherein the raised outer ridge extends from the top of the base substantially perpendicularly.

18. The bucket seat accessory organizer of claim 1, wherein the lid is formed from a UV-resistant material.

19. The bucket seat accessory organizer of claim 18, wherein the lid comprises a plurality of raised diamond-shaped protrusions disposed in a pattern across a top surface of the lid.

20. The bucket seat accessory organizer of claim 1, wherein the lid comprises a plurality of ridges extending from the lower surface of the lid; and
wherein each of the plurality of ridges are aligned with one of a plurality of support walls formed in the base.
